(19) United States
(12) Patent Application Publication
(10) Pub. No.: US 2018/0053267 A1
(43) Pub. Date: Feb. 22, 2018

(54) DYNAMIC MULTI-FACTOR OPTIMIZATION OF ONLINE TRANSACTIONS

(71) Applicant: PlumBid, Inc., Pasadena, CA (US)

(72) Inventors: George E. Penner, Pasadena, CA (US); Michael P. Deasy, Santa Monica, CA (US); Galen R. Loram, Los Angeles, CA (US)

(21) Appl. No.: 15/243,149

(22) Filed: Aug. 22, 2016

(51) Int. Cl. G06Q 50/16; G06Q 30/08; G06Q 40/02

(52) U.S. Cl. CPC G06Q 50/16; G06Q 40/025; G06Q 30/08

(57) ABSTRACT

The disclosed embodiments provide a system for conducting an online transaction. During operation, the system displays a user interface for specifying a set of bid parameters associated with an offer in the online transaction containing a real estate auction of a property, wherein the set of bid parameters comprises a cash percentage of the offer, an escrow length, an inspection contingency, and an offer price. Next, the system uses one or more seller preferences for the real estate auction and the bid parameters to calculate an effective bid for the offer. The system then displays the effective bid in the user interface and dynamically adjusts the effective bid based on one or more changes to the bid parameters received through the user interface. Upon receiving a submission of the offer through the user interface, the system updates the real estate auction with the effective bid in the offer.

### BACKGROUND

### Field

The disclosure relates to techniques for improving online transactions. More specifically, the disclosure relates to techniques for performing dynamic multi-factor optimization of online transactions.

### Related Art

Transactions such as business transactions, financial transactions, and/or database transactions are commonly conducted using computer technology. For example, transactions involving sequences of interdependent operations may be carried out using distributed hardware and/or software. In turn, the use of electronic devices, computer systems, and/or computer networks to carry out such transactions may improve the automation, efficiency, speed, availability, scalability, verifiability, scope, and reach of the transactions.

### SUMMARY

The disclosed embodiments provide a system for conducting an online transaction. During operation, the system displays a user interface for specifying a set of bid parameters associated with an offer in the online transaction containing a real estate auction of a property, wherein the set of bid parameters includes a cash percentage of the offer, an escrow length, an inspection contingency, and an offer price. Next, the system uses one or more seller preferences for the real estate auction and the bid parameters to calculate an effective bid for the offer. The system then displays the effective bid in the user interface and dynamically adjusts the effective bid based on one or more changes to the bid parameters received through the user interface. Upon receiving a submission of the offer through the user interface, the system updates the real estate auction with the effective bid in the offer.

In one or more embodiments, the system also includes one or more factors associated with the real estate auction in calculating the effective bid.

In one or more embodiments, the one or more factors include a Mortgage Credit Availability Index (MCAI) for a loan associated with the offer.

In one or more embodiments, the system also calculates a minimum price for the real estate auction from a real estate price index and a previous sale price of the property.

In one or more embodiments, the system also selects the offer as a winning offer for the real estate auction when the effective bid of the offer exceeds the minimum price and other effective bids in the real estate auction at an end time of the real estate auction.

In one or more embodiments, the system also selects one or more other offers in the real estate auction as backup offers for purchasing the property.

In one or more embodiments, the system also automatically extends the end time when the offer is submitted within a pre-specified period before the end time.

In one or more embodiments, the one or more seller preferences include an importance of one or more of the bid parameters.

In one or more embodiments, using the one or more seller preferences and the bid parameters to calculate the effective bid for the offer includes calculating the effective bid from the offer price and a product containing the importance of the cash percentage and the cash percentage of the offer.

In one or more embodiments, the one or more seller preferences include a preferred escrow length.

In one or more embodiments, using the one or more seller preferences and the bid parameters to calculate the effective bid for the offer includes calculating the effective bid from the offer price and a difference between the escrow length and the preferred escrow length.

In one or more embodiments, using the one or more seller preferences and the bid parameters to calculate the effective bid for the offer includes calculating the effective bid to be higher than the offer price when the bid parameters include a waiving of the inspection contingency.

### BRIEF DESCRIPTION OF THE DRAWINGS

FIG. 1 shows a schematic of a system in accordance with one or more embodiments.

FIG. 2 shows a system for improving an online transaction in accordance with one or more embodiments.

FIG. 3A shows an exemplary screenshot in accordance with one or more embodiments.

FIG. 3B shows an exemplary screenshot in accordance with one or more embodiments.

FIG. 3C shows an exemplary screenshot in accordance with one or more embodiments.

FIG. 4 shows a flowchart illustrating the process of performing an online transaction in accordance with one or more embodiments.

FIG. 5 shows a computer system in accordance with one or more embodiments.

In the figures, like elements are denoted by like reference numerals.

### DETAILED DESCRIPTION

In the following detailed description, numerous specific details are set forth to provide a thorough understanding of the disclosed embodiments. However, it will be apparent to those skilled in the art that the disclosed embodiments may be practiced without these specific details. In other instances, well-known features have not been described in detail to avoid unnecessarily complicating the description.

Methods, structures, apparatuses, modules, and/or other components described herein may be enabled and operated using hardware circuitry, including but not limited to transistors, logic gates, and/or electrical circuits such as application-specific integrated circuits (ASICs), field-programmable gate arrays (FPGAs), digital signal processors (DSPs), and/or other dedicated or shared processors now known or later developed. Such components may also be provided using firmware, software, and/or a combination of hardware, firmware, and/or software.

The operations, methods, and processes disclosed herein may be embodied as code and/or data, which may be stored on a non-transitory computer-readable storage medium for use by a computer system. The computer-readable storage medium may correspond to volatile memory, non-volatile memory, hard disk drives (HDDs), solid-state drives (SSDs), hybrid disk drives (HDDs), magnetic tape, compact discs (CDs), digital video discs (DVDs), and/or other media capable of storing code and/or data now known or later developed. When the computer system reads and executes the code and/or data stored on the computer-readable storage medium, the computer system performs the methods and processes embodied in the code and/or data.

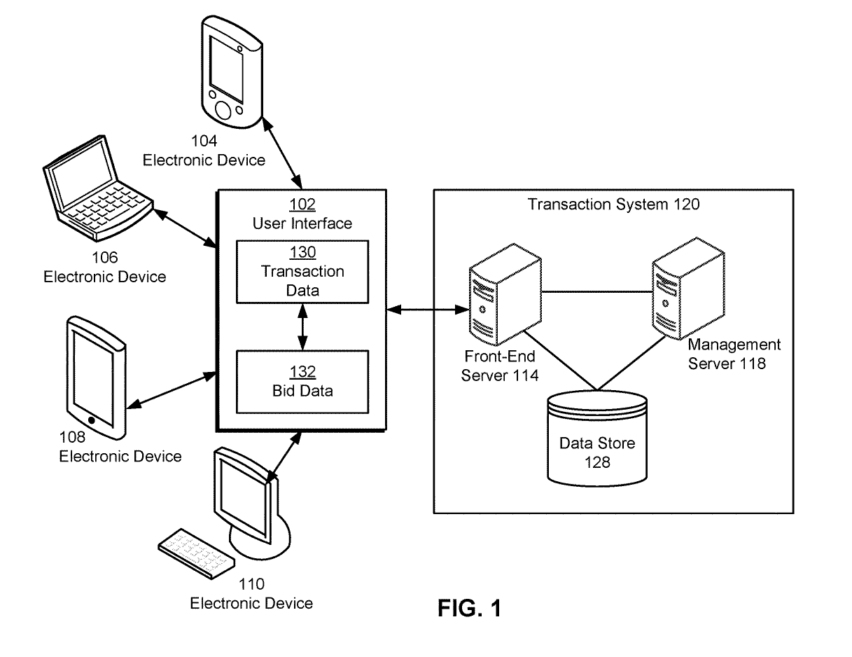

The disclosed embodiments provide a method, apparatus, and system for performing online transactions such as database transactions, business transactions, and/or financial transactions. More specifically, the disclosed embodiments provide a method, apparatus, and system for performing dynamic multi-factor optimization of on-line transactions. As shown in FIG. 1, the system includes a transaction system 120 that executes online transactions through a user interface 102 that is accessed by a set of electronic devices 104-110. For example, user interface 102 may be a graphical user interface, web-based user interface, command-line interface, and/or other type of user interface that is provided by a web browser, mobile application, native application, and/or other application executing on a mobile phone, personal computer, laptop computer, personal digital assistant, tablet computer, portable media player, and/or other type of network-enabled electronic device.

Within user interface 102, transaction data 130 associated with online transactions may be displayed. For example, transaction data 130 for an online auction may include a description of an item (e.g., good or service) being sold, a photograph of the item, shipping or delivery information for the item, and/or a review or rating of the seller of the item.

In turn, users of electronic devices 104-110 may use transaction data 130 for one or more online transactions to generate and submit bid data 132 for bids related to items sold or transacted through the online transactions. Continuing with the previous example, the users may enter and submit dollar or other numeric amounts for bids during the online auction. At the conclusion of the online auction, a winning bid may be selected according to the rules of the online auction. In another example, bid data 132 may include prices, statements of work, and/or other information related to proposals for contracts or projects.

To enable online transactions and/or other types of interactions through user interface 102, a front-end server 114 in transaction system 120 may query a data store 128 for transaction data 130 and/or other information related to the transactions and/or interactions. Front-end server 114 may also generate user-interface elements such as text boxes, images, audio, video, buttons, sliders, drop-down menus, checkboxes, and/or form fields for displaying, searching, filtering, entering, modifying, and/or submitting transaction data 130 and/or bid data 132 through user interface 102. Front-end server 114 may persist some or all of the data submitted through user interface 102 in data store 128 and/or another storage mechanism and/or update user interface 102 with the submitted data. For example, front-end server 114 may store bid data 132 for each valid bid submitted in an online auction in a relational database, filesystem, and/or other storage mechanism providing data store 128. Front-end server 114 may also update user interface 102 for all participants in the online auction with some or all of the bid data.

A management server 118 in transaction system 120 may allow an administrator and/or other user to create, customize, and/or manage online transactions in transaction system 120. For example, management server 118 may provide one or more components of user interface 102 and/or another user interface for entering details, prices, start and end times, and/or other information related to new and/or existing online auctions. Management server 118 may also allow the administrator to register and/or approve bidders for the online auction, if bidding in the online auction is restricted to an eligible subset of users.

In one or more embodiments, front-end server 114 and management server 118 include functionality to dynamically optimize online transactions conducted through transaction system 120. Such optimization may be based on multiple factors associated with the online transactions, such as parameters that may influence the sale of a property in a real estate auction.

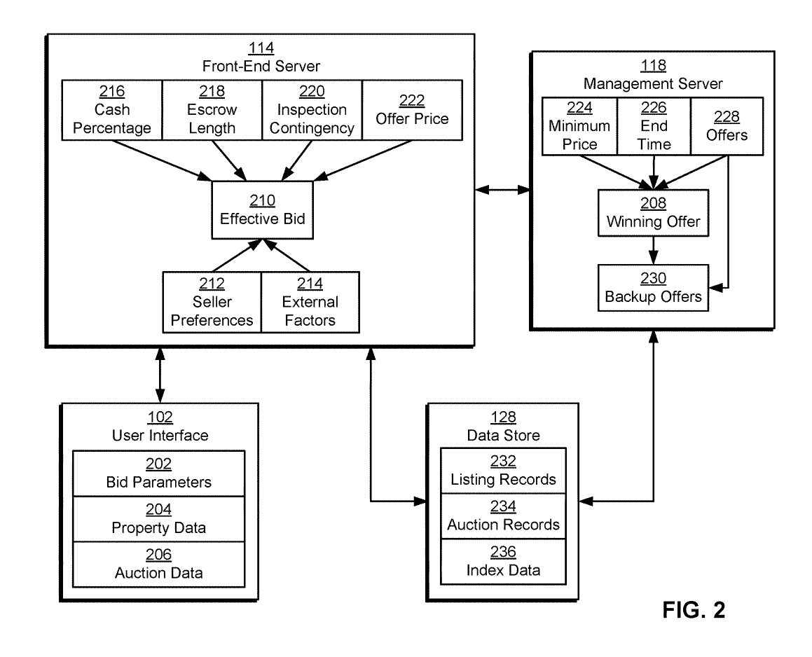

As shown in FIG. 2, data store 128 may include a number of listing records 232 for properties such as residential homes, multi-family properties, land, and/or commercial properties. Each listing record may include, for example, an address, tax ID number, details, description, features, neighborhood information, photos, property history, and/or other relevant information for the corresponding property. The listing record may additionally include and/or reference disclosure statements, inspection reports, title reports, comparative market analyses, appraisal reports, and/or other documents related to the sale of the property. Some or all data elements in the listing record and/or associated documents may be displayed and/or downloaded as property data 204 in user interface 102.

Some or all data elements in listing records 232 may also be obtained from and/or published in a multiple listing service (MLS). For example, fields in a listing record may be inputted into user interface 102 and/or another user interface associated with listing a property for sale by an agent and/or other representative of the seller. Alternatively, one or more portions of the listing record and/or associated documents may be imported from the MLS and/or another platform.

Data store 128 may also include a number of auction records 234 for properties to be transacted through real estate auctions. Each auction record may include a number of parameters and/or rules for conducting the corresponding real estate auction. For example, each auction record may include a start time, duration, end time 226, minimum price 224 to be met or exceeded by a winning bid (e.g., starting bid, reserve price), currency, auction type (e.g., ascending, descending, blind, first-price, second-price, non-reserve, minimum reserve, etc.), bidding eligibility requirements (e.g., loan pre-qualification, due diligence, etc.), and/or other attributes associated with the corresponding auction. Some or all data elements in the auction record may be displayed as auction data 206 in user interface 102 by front-end server 114.

As with listing records 232, auction records 234 may be created by a seller, the seller's representative, an administrator, and/or another user with access to management server 118. One or more portions of an auction record may also, or instead, by imported from a different auction record in data store 128 and/or another auction platform.

Each auction record may also identify a listing record of a property to be offered for sale in the auction. For example, the auction record may include a field containing an identifier for the listing record in data store 128. During the real estate auction, the auction record and corresponding auction data 206 in user interface 102 may be updated with offer price 222 and/or other attributes of offers submitted by bidders and/or representatives of the bidders in the real estate auction. Alternatively, one or more of the attributes may be hidden from user interface 102 to reflect the rules and/or format of the real estate auction.

In one or more embodiments, auction records 234 include a number of seller preferences 212 related to the sale of the corresponding properties. Seller preferences 212 may be obtained by an administrator, agent, and/or other user representing a seller of a property and entered with other attributes of auction records 234 into user interface 102 and/or another user interface provided by management server 118. Some or all seller preferences 212 may also, or instead, be provided directly by the seller to the user interface, management server 118, and/or another component of the system. Some or all seller preferences 212 may additionally be imported from previous auction records for the seller and/or similar sellers.

Seller preferences 212 may include attributes or aspects of offers that are important to the seller. Illustratively, seller preferences 212 may pertain to a cash percentage 216, escrow length 218, inspection contingency 220, offer price 222, and/or other bid parameters 202 of an offer in the real estate auction. For example, seller preferences 212 may include a rating, score, dollar value, and/or other indication of the importance of a given bid parameter to the seller. Seller preferences 212 may also, or alternatively, include a value of the bid parameter, such as a preferred escrow length 218 and/or minimum price 224 to be met by offers 228 in the real estate auction.

To initiate a real estate auction, management server 118 may retrieve the corresponding listing record and auction record from data store 128. Management server 118 may obtain the start time and end time 226 of the real estate auction from the auction record and/or select a start and/or end time for the real estate auction based on other data in the auction and/or listing record (e.g., days on market, seller preferences 212, length of auction, etc.).

Management server 118 may also obtain and/or calculate minimum price 224 as a hidden reserve price, an opening bid, and/or another price to be met or exceeded by a winning offer 208 in the real estate auction. For example, management server 118 may obtain minimum price 224 as a seller preference from the auction record for the real estate auction. Management server 118 may also, or instead, calculate minimum price 224 from data in the listing record, auction record, and/or index data 236 containing a real estate price index for the corresponding property. For example, management server 118 may set minimum price 224 to be a percentage (e.g., 80%) of the property's appraised value. In another example, management server 118 may calculate minimum price 224 using the following formula:

```
minimum_price =
  0.85 * current_index/previous_index *
  previous_sale_price
```

In the above formula, “minimum_price” represents minimum price 224, “current_index” represents a current real estate price index associated with the property (e.g., Case-Shiller index for the metropolitan area of the property), “previous_index” represents the real estate price index at the time of the property's most recent sale, and “previous_sale_price” represents the property's most recent sale price. In other words, minimum price 224 may be set to 85% of the property's most recent sale price, which is scaled by an index ratio that captures the appreciation or depreciation of real estate in the property's area since the property's most recent sale.

During the real estate auction, bidders may generate offers 228 by entering bid parameters 202 containing values of cash percentage 216, escrow length 218, inspection contingency 220, and/or offer price 222 into user interface 102. Each bidder may include a potential buyer of the property, an agent or representative of the potential buyer, and/or another user that is registered with the transaction system and approved as a participant in the real estate auction. The bidder may log in through user interface 102 to access the real estate auction and generate an offer by entering bid parameters 202 for the offer into user interface 102. The bidder may also be restricted to values of bid parameters 202 that can be met by the corresponding buyer. For example, the bidder may vary offer price 222 and cash percentage 216 in an offer, up to pre-approved values of 50% at $1,000,000 for the buyer.

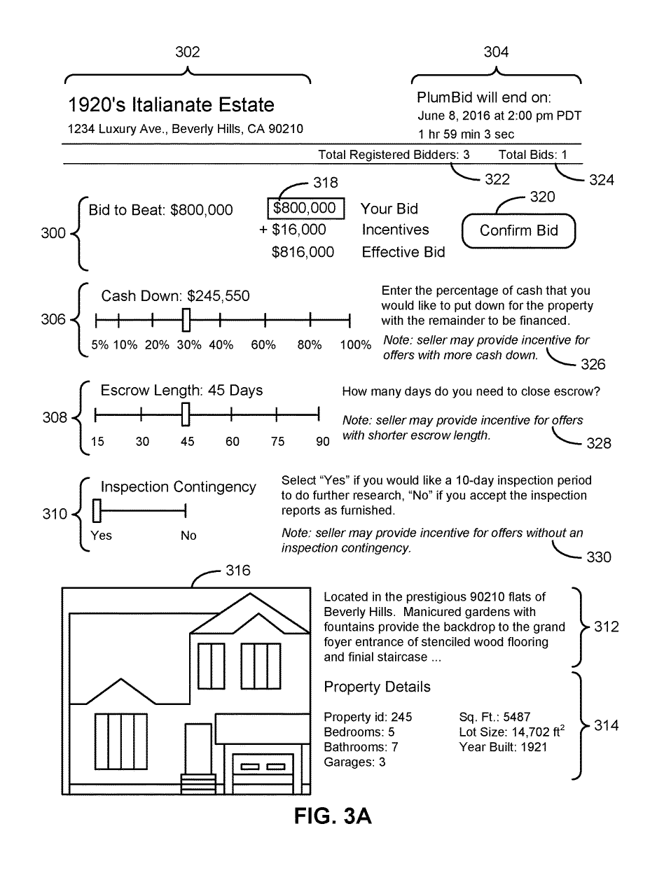

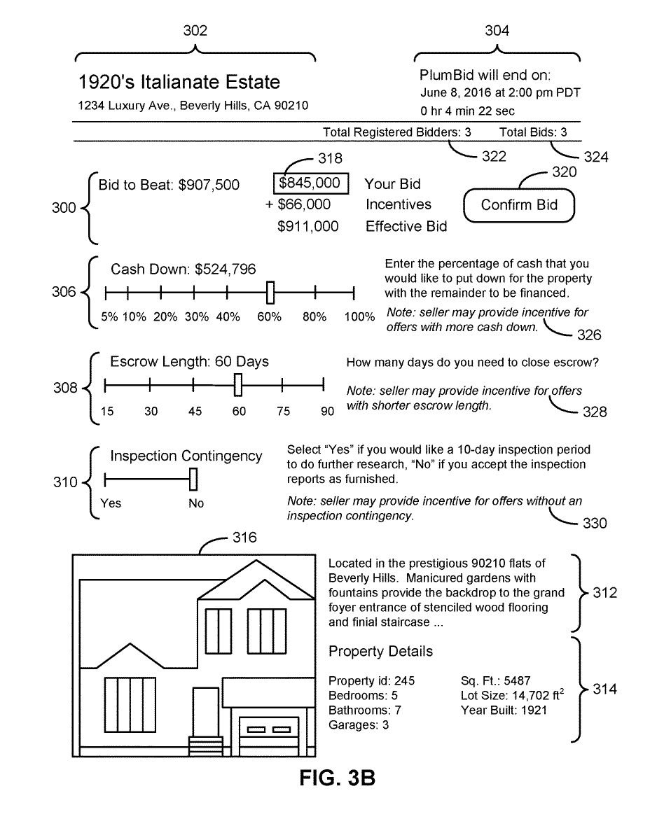

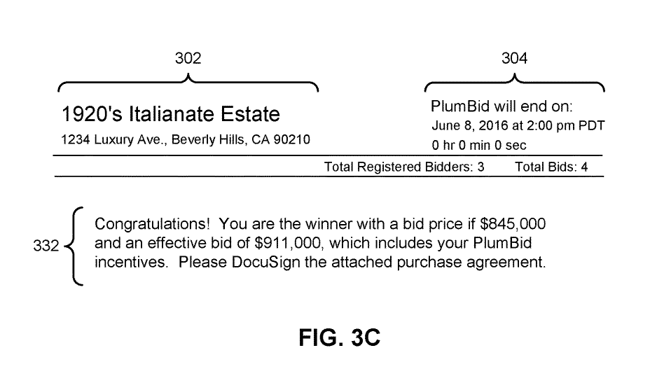

Front-end server 114 and/or another component associated with user interface 102 may combine the entered bid parameters 202 with seller preferences 212 and/or a number of external factors 214 to calculate an effective bid 210 for the offer. The component may display the calculated effective bid 210 in user interface 102 and dynamically update the displayed value based on changes to bid parameters 202 from the bidder. User interfaces for calculating and displaying effective bids in real estate auctions are described in further detail below with respect to FIGS. 3A-3C.

In one or more embodiments, effective bid 210 is a “virtual” dollar and/or other numeric amount that adjusts offer price 222 to reflect the alignment of bid parameters 202 with seller preferences 212. For example, effective bid 210 may include a dollar value increase over offer price 222 when bid parameters 202 are in line with seller preferences 212. On the other hand, effective bid 210 may provide a lower dollar value increase over offer price 222 and/or a decrease in dollar value from offer price 222 when bid parameters 202 are not in line with seller preferences 212. Consequently, effective bid 210 may account for a number of potential “incentives” that reflect the priorities of the seller and/or external factors 214 in evaluating an offer submitted in the real estate auction.

As mentioned above, seller preferences 212 may include indicators of importance and/or values associated with cash percentage 216, escrow length 218, inspection contingency 220, and/or other bid parameters 222. One or more formulas in a mathematical model may be applied to seller preferences 212, external factors 214, and bid parameters 202 (e.g., cash percentage 216, escrow length 218, inspection contingency 220, offer price 222) to produce effective bid 210. If the seller fails to provide values for one or more seller preferences 212, default values may be used, or calculation of effective bid 210 using the values may be omitted.

For example, seller preferences 212 for cash percentage 216 may include a numeric score ranging from 1 to 5 that represents an importance of cash percentage 216 to the seller, with 1 representing “not important,” 2 representing “somewhat important,” 3 representing “important,” 4 representing “very important,” and 5 representing “extremely important.” In turn, the calculation of effective bid 210 may include a “cash percentage adjustment” that is added to offer price 222 and calculated using the following exemplary formula:

```
cash_percentage_adjustment =
  offer_price * 0.1 * EXP(-MCAI/100) * (importance - 1)
  * LOG10(cash_percentage/20)
```

In the above formula, “cash percentage adjustment” represents the cash percentage adjustment, “offer price” represents offer price 222, “importance” represents the numeric score, and “cash percentage” represents cash percentage 216. “MCAI” represents a Mortgage Credit Availability Index (MCAI) for the type of loan (e.g., conforming, jumbo, standard, government) required by the offer, which may be obtained as an external factor (e.g., external factors 214) from index data 236 in data store 128 and/or another source (e.g., public records). Thus, offer price 222 may be increased by a value of up to 10-11% when the offer is all cash and the importance is set to 5. Offer price 222 may remain unchanged if cash percentage 216 is set to a standard down payment of 20% and/or the numeric score is set to 1. Offer price 222 may additionally be reduced by a value of up to 10% when cash percentage 216 falls below 20% and the importance is set to 5. The increase or decrease in offer price 222 may additionally be modulated by an exponential component (i.e., “EXP(−MCAI/100)”) that reflects the current availability of mortgage credit for the type of loan required by the offer.

In another example, seller preferences 212 for escrow length 218 may include a preferred escrow length in number of days. The calculation of effective bid 210 may include an “escrow length adjustment” that is added to offer price 222 and calculated using the following exemplary formula:

```
escrow_length_adjustment =
  offer_price * (2 - (1/15) * |escrow_length −
  preferred_escrow_length|) * 0.01
```

In the above formula, “escrow_length_adjustment” represents the escrow length adjustment, “escrow_length” represents escrow length 218, and “preferred_escrow_length” represents the seller's preferred escrow length. As a result, a value of escrow length 218 that matches or is close to the preferred escrow length may increase offer price 222 by up to 2%, while a value of escrow length 218 that deviates from the preferred escrow length may decrease offer price 222 by up to 3% (e.g., when the difference between escrow length 218 and the preferred escrow length is 75 days). As with the formula for calculating the cash percentage adjustment, the escrow length adjustment formula may include an optional component that scales the percentage increase or decrease in offer price by an amount that reflects the importance of escrow length 218 to the seller.

The formula above may also be changed to model the escrow length adjustment with a parabolic and/or bell-shaped curve that is centered around the preferred escrow length. As a result, the escrow length adjustment may be highest when escrow length 218 exactly matches the seller's preferred escrow length and decrease as escrow length 218 deviates from the preferred escrow length.

In a third example, seller preferences 212 may include an incentive or bonus for waiving inspection contingency 220. The incentive or bonus may be fixed (e.g., at 5% of offer price 222) and/or set by the seller and/or the seller's representative as a dollar value and/or percentage of offer price 222. The incentive or bonus may optionally be scaled based on the importance of waiving inspection contingency 220 to the seller.

Effective bid 210 may thus be calculated by combining offer price 222 with adjustments to offer price 222 that are based on seller preferences 212 and other bid parameters 202 in the offer. For example, effective bid 210 may be calculated by combining the output of the previous three formulas in the following way:

```
effective_bid =
  offer_price + cash_percentage_adjustment +
  escrow_length_adjustment +
  inspection_contingency_adjustment
```

In the above formula, “effective_bid” represents effective bid 210 and “inspection_contingency_adjustment” represents any incentive or bonus for waiving inspection contingency 220.

Those skilled in the art will appreciate that seller preferences 212 and/or bid parameters 202 may be specified and/or used to calculate effective bid 210 in other ways. For example, seller preferences 212 may include explicit dollar and/or percentage increases or decreases in offer price 222 for various values of cash percentage 216, escrow length 218, inspection contingency 220, and/or other bid parameters 202. In turn, effective bid 210 may be calculated by matching the values of bid parameters 202 to the corresponding adjustments in value from seller preferences 212 and applying the adjustments to offer price 222. In another example, a regression model, decision tree, Bayesian network, artificial neural network, support vector machine, and/or other type of statistical model may be used to generate effective bid 210 based on bid parameters 202 and explicit or inferred seller preferences 212.

Those skilled in the art will also appreciate that effective bid 210 may also include adjustments of offer price 222 for other types of seller preferences 212 and/or bid parameters 202. For example, front-end server 114 may include, in effective bid 210, an adjustment of offer price 222 that is based on a bidder's loan pre-qualification, loan pre-approval, credit rating, income, prior real estate purchases, and/or other attributes.

After a given offer is submitted in the real estate auction, the value of effective bid 210 in the offer may be propagated to user interface 102 for other bidders in the same real estate auction. In turn, another bidder may respond to the submitted offer by updating offer price 222 and/or bid parameters 202 of additional offers 228 to produce a higher value of effective bid 210. The other bidder may then submit the higher value in a subsequent offer in an attempt to win the real estate auction. Alternatively, values of effective bid 210 in submitted offers may be hidden from other bidders in the real estate auction if the real estate auction is to be conducted in a sealed-bid format.

Each offer submitted to front-end server 114 through user interface 102 may be also be persisted in the corresponding auction record in data store 128 and/or transmitted to management server 118 for use in conducting the real estate auction. If the offer is submitted within a pre-specified period (e.g., five minutes) before an end time 226 of the real estate auction, management server 118 may automatically extend end time 226 by the same period and/or a different period to prevent auction sniping by the bidders.

At the close of the real estate auction (e.g., after end time 226 has been surpassed), management server 118 may select a winning offer 208 and/or one or more backup offers 230 from offers 228 submitted by the bidders. For example, management server 118 may select winning offer 208 as the offer with the highest effective bid 210 that also meets or exceeds minimum price 224. Management server 118 may also select backup offers 230 for purchasing the property from remaining offers 228 in the real estate auction, in the event that the buyer associated with winning offer 208 is unable to complete the sale. Management server 118 and/or another component of the system may generate notifications of winning offer 208 and backup offers 230 to the corresponding bidders and initiate steps necessary to complete the sale. After the sale closes, the component may update data store 128 with documents, personal information, and/or parameters related to the sale for personalization or customization of subsequent real estate auctions for both buyers and sellers, as well as lead generation, customer relationship management, and/or other activities conducted by agents or brokerages.

By conducting real estate auctions and/or other types of online transactions using bid parameters 202, seller preferences 212, external factors 214, and/or effective bid 210, the system of FIG. 2 may reduce the complexity and/or overhead associated with manually comparing offers for the same property, good, and/or service. At the same time, the propagation of the highest and/or most recent effective bid 210 in a given online transaction to other bidders may increase the transparency of the online transaction and seller preferences 212 for the bidders, thereby enabling the bidders to optimize their bids in ways that are advantageous to both the bidders and the seller. Consequently, the system of FIG. 2 may improve or automate the use of online transaction technology by allowing online transactions to be conducted based on personalized and/or dynamically adjustable bid parameters 202, seller preferences 212, and/or external factors 214. In turn, such improvements may increase the adoption and use of online transaction technology by buyers, sellers, and/or other users with roles in online transactions.

Those skilled in the art will appreciate that the system of FIG. 2 may be implemented in a variety of ways. For example, front-end server 114, management server 118, user interface 102, and data store 128 may be provided by a single physical machine, multiple computer systems, one or more virtual machines, a grid, one or more databases, one or more filesystems, and/or a cloud computing system. Front-end server 114, management server 118, and user interface 102 may additionally be implemented together and/or separately by one or more hardware and/or software components and/or layers.

Those skilled in the art will also appreciate that the system of FIG. 2 may be applied to other types of online transactions. For example, the functionality of front-end server 114, management server 118, user interface 102, and/or other components of the system may be used to optimize online transactions for renting or leasing properties, vehicles, and/or other goods or services.

FIG. 3A shows an exemplary screenshot in accordance with one or more embodiments. More specifically, FIG. 3A shows a screenshot of a user interface for a transaction system, such as user interface 102 of FIG. 1. As discussed above, the user interface may be used to generate and submit a bid during a real estate auction of a property.

The top of the user interface includes an overview 302 of the property, which provides a name and/or title of the property (e.g., “1920's Italianate Estate”) and an address of the property (e.g., “1234 Luxury Ave., Beverly Hills, CA 90210”). The user interface also includes timing information 304 for the real estate auction, which specifies an end time of the real estate auction (e.g., “June 8, 2016 at 2:00 pm PDT”) and a time remaining in the real estate auction (e.g., “1 hr 59 min 3 sec”). The user interface additionally includes bidding counts for the real estate auction, including a number of registered bidders 322 (e.g., “3”) and a number of bids 324 submitted thus far in the real estate auction (e.g., “1”).

Next, the user interface includes bid information 300 related to an offer that is being generated by a bidder. Bid information 300 specifies a bid to beat of $800,000 (e.g., from a previously submitted offer), a current offer price of $800,000 that is entered into a user-interface element 318 (e.g., a text box), incentives of $16,000, and an effective bid of $816,000 that is obtained by adding the offer price and the incentives. The bidder may select a user-interface element 320 (e.g., “Confirm Bid”) to submit the offer with the current effective bid shown in bid information 300.

Below bid information 300, the bidder may interact with a number of components 306-310 to specify bid parameters that are used to calculate the incentives and effective bid of the offer. Component 306 may include a slider that allows the bidder to select a cash percentage of the offer, which is currently set at 30%. Component 308 may include a slider that allows the bidder to specify an escrow length for the offer, which is currently set at 45 days. Component 310 includes a slider and/or toggle that allows the bidder to require or waive an inspection contingency for the sale of the property.

Components 306-310 may also include suggestions 326-330 for increasing the values of incentives and/or the effective bid based on the corresponding bid parameters. For example, suggestion 326 in component 306 may describe an incentive for an increased cash percentage in the offer, suggestion 328 in component 308 may describe an incentive for a shorter escrow length, and suggestion 330 in component 310 may describe an incentive for waiving the inspection contingency.

To assist the bidder with identifying and/or evaluating the property, the user interface further includes a component 316 displaying one or more photos of the property, a component 312 containing a description of the property, and a component 314 containing details of the property. As a result, components 312-316 may provide information that is found in a listing record of the property.

FIG. 3B shows an exemplary screenshot in accordance with one or more embodiments. More specifically, FIG. 3B shows the user interface of FIG. 3A at a later point in the real estate auction. As shown in FIG. 3B, number of bids 324 has been increased from 1 to 3, timing information 304 indicates an end of the real estate auction in four minutes and 22 seconds, and bid information 300 includes a bid to beat of $907,500 and an offer with an offer price of $845,000, incentives of $66,000, and an effective bid of $911,000.

Components 306-310 are also updated to reflect changes to the bid parameters that result in the incentives and effective bid in bid information 300. Component 306 includes an increase in cash percentage from 30% to 60%, component 308 includes a change in escrow length from 45 days to 60 days, and component 310 includes a change from requiring the inspection contingency to waiving of the inspection contingency. Because the incentives and effective bid are increased over the bidder's previous offer in FIG. 3A, the bid parameters of FIG. 3B may better reflect seller preferences for the real estate auction than the bid parameters of FIG. 3A.

FIG. 3C shows an exemplary screenshot in accordance with one or more embodiments. More specifically, FIG. 3C shows the user interface of FIGS. 3A-3B after the offer shown in FIG. 3B has been selected as a winning offer at the conclusion of the real estate auction.

As shown in FIG. 3C, the user interface is updated with a message 332 notifying the bidder of the winning offer. The message may specify the offer price of $845,000 and effective bid of $911,000 in the winning offer. The message may also provide instructions for proceeding with the sale (e.g., “Please DocuSign the attached purchase agreement”).

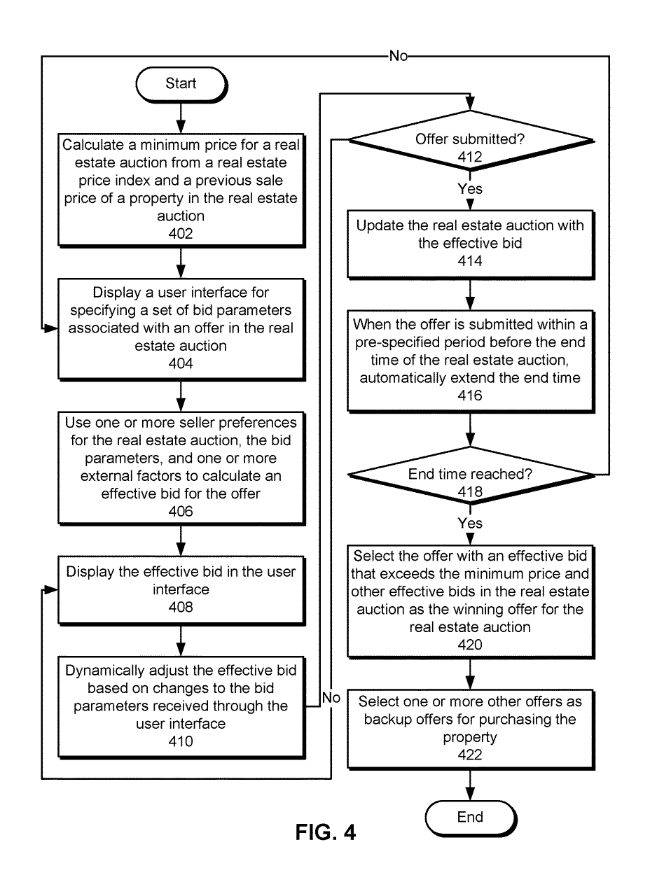

FIG. 4 shows a flowchart illustrating the process of performing an online transaction in accordance with one or more embodiments. In one or more embodiments, one or more of the steps may be omitted, repeated, and/or performed in a different order. Accordingly, the specific arrangement of steps shown in FIG. 4 should not be construed as limiting the scope of the embodiments.

Initially, a minimum price of a real estate auction is calculated from a real estate price index and a previous sale price of a property in the real estate auction (operation 402). For example, the minimum price may be calculated as a percentage (e.g., 85%) of the previous sale price scaled by a real estate price index that tracks the appreciation or depreciation of real estate in the property's area. As a result, the minimum price may be set to a value that both ensures a fair winning bid for the seller of the property and encourages bidders to participate in the real estate auction. The minimum price may then be used as a reserve price, opening bid, and/or other price that enforces a lower limit on the offer price and/or effective bid of the winning offer in the real estate auction.

Next, a user interface for specifying a set of bid parameters associated with an offer in the real estate auction is displayed (operation 404). For example, the user interface may be displayed within a web browser, application, and/or terminal within a personal computer, laptop computer, tablet computer, mobile phone, portable media player, and/or other network-enabled electronic device. Within the user interface, one or more user-interface components (e.g., sliders, drop-down menus, checkboxes, buttons, dials, text boxes, form fields, etc.) may be used to obtain values of the bid parameters from a bidder in the real estate auction. The bid parameters may include, but are not limited to, a cash percentage of the offer, an escrow length, an inspection contingency, and/or an offer price.

An effective bid for the offer is then calculated using one or more seller preferences for the real estate auction, the bid parameters, and one or more external factors (operation 406) associated with the real estate auction. For example, the effective bid may be calculated by using a mathematical and/or statistical model to augment the offer price based on a compatibility of the bid parameters with the seller preferences.

The seller preferences may include an importance of one or more bid parameters and/or a value of a specific bid parameter. For example, the seller preferences may specify an importance of the cash percentage in the offer to the seller, and the effective bid may be calculated from the offer price, the MCAI for the type of loan associated with the offer and/or another external factor that gauges ease of financing for the property, and a product of the importance of the cash percentage and the cash percentage of the offer. In another example, the seller preferences may include a preferred escrow length, and the effective bid may be calculated from the offer price and a difference between the escrow length and the preferred escrow length. In a third example, the seller preferences may include a preference for waiving of the inspection contingency, and the effective bid may be calculated to be higher than the offer price when the bid parameters specify a waiving of the inspection contingency.

After the effective bid is calculated, the effective bid is displayed in the user interface (operation 408) and dynamically adjusted based on changes to the bid parameters received through the user interface (operation 410). For example, the value of the effective bid may be recalculated and refreshed in the user interface as the bidder interacts with user-interface elements to change one or more bid parameters. Such interaction may allow the bidder to find a combination of bid parameters that is acceptable to the bidder and optimizes the value of the offer in the real estate auction.

The offer may be submitted by the bidder (operation 412). For example, the offer may be submitted after the bidder arrives at suitable values for bid parameters and/or the effective bid in the offer. If the offer has not been submitted, the effective bid may continue to be displayed in the user interface (operation 408) and dynamically adjusted based on changes to the bid parameters (operation 410).

After the offer is submitted and accepted, the real estate auction is updated with the effective bid (operation 414). For example, the real estate auction and user interface may be updated to identify the effective bid of the offer as the current highest bid. The end time of the auction is also extended when the offer is submitted within a pre-specified period before the end time (operation 416). For example, submission of the offer within the last five minutes of the end time may result in an automatic extension of the real estate auction by an additional five minutes.

The end time of the real estate auction may be reached (operation 418) once offers are no longer submitted. If the end time is not reached, the user interface may continue to be used to specify, update, and/or submit bid parameters and the effective bid of additional offers (operations 404-412), the real estate auction may be updated with newly submitted offers (operation 414), and the end time of the real estate auction may optionally be extended (operation 416).

Once the end time is reached, the offer with an effective bid that exceeds the minimum price and other effective bids in the real estate auction is selected as the winning offer for the real estate auction (operation 420). One or more other offers are also selected as backup offers for purchasing the property (operation 422). For example, bidders associated with the backup offers may be given the opportunity to purchase the property at the winning offer price, in the event that the buyer associated with the winning offer is unable to complete the sale.

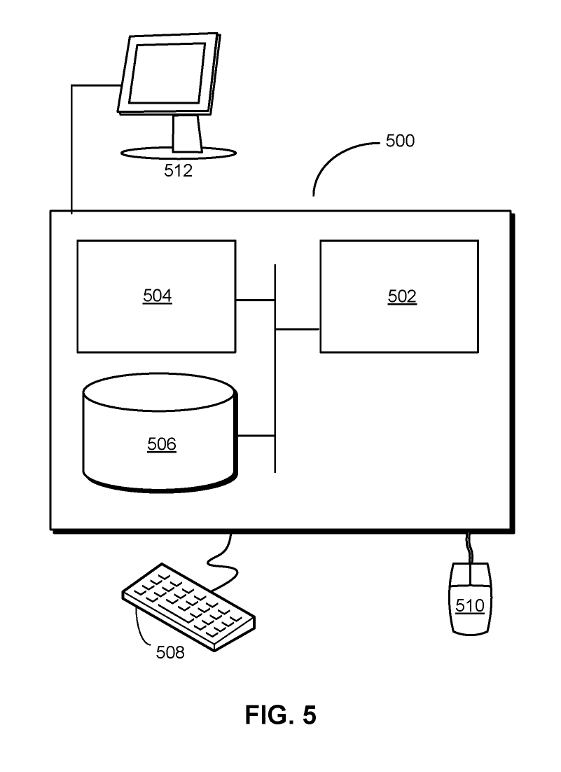

FIG. 5 shows a computer system 500. Computer system 500 includes a processor 502, memory 504, storage 506, and/or other components found in electronic computing devices. Processor 502 may support parallel processing and/or multi-threaded operation with other processors in computer system 500. Computer system 500 may also include input/output (I/O) devices such as a keyboard 508, a mouse 510, and a display 512.

Computer system 500 may include functionality to execute various components of the present embodiments. In particular, computer system 500 may include an operating system (not shown) that coordinates the use of hardware and software resources on computer system 500, as well as one or more applications that perform specialized tasks for the user. To perform tasks for the user, applications may obtain the use of hardware resources on computer system 500 from the operating system, as well as interact with the user through a hardware and/or software framework provided by the operating system.

In one or more embodiments, computer system 500 provides a system for conducting an online transaction. The system may include a front-end server and a management server. The front-end server may display a user interface for specifying a set of bid parameters (e.g., cash percentage, escrow length, inspection contingency, offer price, etc.) associated with an offer in the online transaction, which includes a real estate auction of a property. Next, the front-end server may use one or more seller preferences for the real estate auction and the bid parameters to calculate an effective bid for the offer and display the effective bid in the user interface. The front-end server may also dynamically adjust the effective bid based on one or more changes to the bid parameters received through the user interface. Upon receiving a submission of the offer through the user interface, the management server may update the real estate auction with the effective bid in the offer.

In addition, one or more components of computer system 500 may be remotely located and connected to the other components over a network. Portions of the present embodiments (e.g., front-end server, management server, user interface, data store, etc.) may also be located on different nodes of a distributed system that implements the embodiments. For example, the present embodiments may be implemented using a cloud computing system that conducts online transactions involving a set of remote users and/or electronic devices.

Although the disclosed embodiments have been described with respect to a limited number of embodiments, those skilled in the art, having benefit of this disclosure, will appreciate that many modifications and changes may be made without departing from the spirit and scope of the disclosed embodiments. Accordingly, the above disclosure is to be regarded in an illustrative rather than a restrictive sense. The scope of the embodiments is defined by the appended claims.

What is claimed is:

1. A method, comprising:
displaying, by one or more computer systems, a user interface for specifying a set of bid parameters associated with an offer in an online transaction comprising a real estate auction of a property, wherein the set of bid parameters comprises a cash percentage of the offer, an escrow length, an inspection contingency, and an offer price;
using one or more seller preferences for the real estate auction and the bid parameters to calculate, by the one or more computer systems, an effective bid for the offer;
displaying the effective bid in the user interface;
dynamically adjusting the effective bid based on one or more changes to the bid parameters received through the user interface; and
upon receiving a submission of the offer through the user interface, updating the real estate auction with the effective bid in the offer.

2. The method of claim 1, further comprising:
including one or more external factors associated with the real estate auction in calculating the effective bid.

3. The method of claim 2, wherein the one or more external factors comprise a Mortgage Credit Availability Index (MCAI) for a loan associated with the offer.

4. The method of claim 1, further comprising:
calculating a minimum price for the real estate auction from a real estate price index and a previous sale price of the property.

5. The method of claim 4, further comprising:
when the effective bid of the offer exceeds the minimum price and other effective bids in the real estate auction at an end time of the real estate auction, selecting the offer as a winning offer for the real estate auction.

6. The method of claim 5, further comprising:
selecting one or more other offers in the real estate auction as backup offers for purchasing the property.

7. The method of claim 1, further comprising:
when the offer is submitted within a pre-specified period before an end time of the real estate auction, automatically extending the end time.

8. The method of claim 1, wherein the one or more seller preferences comprise an importance of one or more of the bid parameters.

9. The method of claim 8, wherein using the one or more seller preferences and the bid parameters to calculate the effective bid for the offer comprises:
calculating the effective bid from the offer price and a product comprising the importance of the cash percentage and the cash percentage of the offer.

10. The method of claim 1, wherein the one or more seller preferences comprise a preferred escrow length.

11. The method of claim 10, wherein using the one or more seller preferences and the bid parameters to calculate the effective bid for the offer comprises:
calculating the effective bid from the offer price and a difference between the escrow length and the preferred escrow length.

12. The method of claim 1, wherein using the one or more seller preferences and the bid parameters to calculate the effective bid for the offer comprises:
calculating the effective bid to be higher than the offer price when the bid parameters comprise a waiving of the inspection contingency.

13. An apparatus, comprising:
one or more processors; and
memory storing instructions that, when executed by the one or more processors, cause the apparatus to:
display a user interface for specifying a set of bid parameters associated with an offer in an online transaction comprising a real estate auction of a property, wherein the set of bid parameters comprises a cash percentage of the offer, an escrow length, an inspection contingency, and an offer price;
use one or more seller preferences for the real estate auction and the bid parameters to calculate an effective bid for the offer;
display the effective bid in the user interface;
dynamically adjust the effective bid based on one or more changes to the bid parameters received through the user interface; and
upon receiving a submission of the offer through the user interface, update the real estate auction with the effective bid in the offer.

14. The apparatus of claim 13, wherein the memory further stores instructions that, when executed by the one or more processors, cause the apparatus to:
calculate a minimum price for the real estate auction from a real estate price index associated with the real estate auction and a previous sale price of the property; and
when the effective bid of the offer exceeds the minimum price and other effective bids in the real estate auction at an end time of the real estate auction, select the offer as a winning offer for the real estate auction.

15. The apparatus of claim 14, wherein the memory further stores instructions that, when executed by the one or more processors, cause the apparatus to:
select one or more other offers in the real estate auction as back-up offers for purchasing the property.

16. The apparatus of claim 13, wherein the one or more seller preferences comprise an importance of one or more of the bid parameters.

17. The apparatus of claim 16, wherein using the one or more seller preferences and the bid parameters to calculate the effective bid for the offer comprises:
calculating the effective bid from the offer price, a Mortgage Credit Availability Index (MCAI) for a loan associated with the offer, and a product comprising the importance of the cash percentage and the cash percentage of the offer.

18. The apparatus of claim 13, wherein using the one or more seller preferences and the bid parameters to calculate the effective bid for the offer comprises:
calculating the effective bid from the offer price and a difference between the escrow length in the offer and a preferred escrow length in the one or more seller preferences.

19. The apparatus of claim 13, wherein using the one or more seller preferences and the bid parameters to calculate the effective bid for the offer comprises:
calculating the effective bid to be higher than the offer price when the bid parameters comprise a waiving of the inspection contingency.

20. A non-transitory computer-readable storage medium containing instructions embodied therein for causing a computer system to perform a method, the method comprising:
displaying a user interface for specifying a set of bid parameters associated with an offer in an online transaction comprising a real estate auction of a property, wherein the set of bid parameters comprises a cash percentage of the offer, an escrow length, an inspection contingency, and an offer price;
using one or more seller preferences for the real estate auction and the bid parameters to calculate an effective bid for the offer;
displaying the effective bid in the user interface;
dynamically adjusting the effective bid based on one or more changes to the bid parameters received through the user interface; and
upon receiving a submission of the offer through the user interface, updating the real estate auction with the effective bid in the offer.
